(19) United States
(12) Patent Application Publication
(10) Pub. No.: US 2007/0232511 A1
(43) Pub. Date: Oct. 4, 2007

(54) Cleaning solutions including preservative compounds for post CMP cleaning processes

(76) Inventors: Matthew Fisher, Allen, TX (US); Ashutosh Misra, Plano, TX (US)

Correspondence Address: Linda K. Russell;Patent Counsel, Air Liquide, 2700 Post Oak Blvd., Suite 1800, Houston, TX, 77056, US

(21) Appl. No.: 11/478,314

(22) Filed: Jun. 30, 2006

Related U.S. Application Data
(60) Provisional application No. 60/786,666, filed on Mar. 28, 2006.

(51) Int. Cl. C11D 7/32

(52) U.S. Cl. 510/175

(57) ABSTRACT

Post CMP cleaning solutions are provided including at least one cleaning agent comprising an organic acid compound, at least one preservative compound that substantially minimizes or prevents microbial growth in the cleaning solution, and at least one amine compound. The preservative compound can be another organic acid compound that protects the cleaning solution against microbial growth. The cleaning solutions preferably have a pH ranging from about 2 to about 7.

### CROSS-REFERENCE TO RELATED APPLICATIONS

This application claims priority from U.S. Provisional Patent Application Ser. No. 60/786,666, entitled “Acidic Chemistry for Post CMP Cleaning of Semiconductor Substrates Containing Copper Interconnects,” and filed Mar. 28, 2006. The disclosure of this provisional patent application is incorporated herein by reference in its entirety.

### BACKGROUND

1. Field

The disclosure pertains to cleaning chemistries for cleaning semiconductor substrates after chemical mechanical polishing and planarization, including the removal of copper residues and oxides, abrasive particles and organic residues.

2. Related Art

Chemical mechanical polishing or planarization (CMP) is a technique utilized in semiconductor fabrication processes in which the top surface of a semiconductor component or substrate is planarized. The semiconductor component is typically a silicon based wafer with active regions formed in or on the wafer and with interconnects formed of a metal (typically copper or tungsten) that is deposited in etched lines along the wafer so as to connect the active regions. The CMP process is used to remove excess copper that has been deposited on the semiconductor component so as to planarize the surface. CMP processes typically involve rotating the semiconductor substrate against a wetted polishing surface under controlled conditions. The chemical polishing agent includes a slurry of an abrasive material (e.g., alumina or silica) and other chemical compounds that interact with the substrate surface during the CMP process.

While CMP is effective in planarizing a substrate surface, this process leaves contaminants at the surface, requiring the application of post CMP cleaning solutions to remove such contaminating residues. For example, copper residues on low k films can degrade the dielectric properties of such films, while other particles from the CMP process can increase the contact resistance, limit the conductivity of the interconnect material and lead to poor adhesion of overlying layers. Therefore, such particles or residues must be removed from the substrate surface in a post CMP cleaning process.

A number of chemistries are known for post CMP cleaning of semiconductor components. In particular, certain cleaning chemistries or solutions are alkaline, including strong basic compounds such as quaternary ammonium hydroxides that inhibit or prevent re-adhesion of particles that are removed from the component surface during cleaning. Other cleaning solutions are acidic and include one or more suitable acids to ensure sufficient dissolution and removal of metal impurities from the component surface. Further still, cleaning chemistries can include combinations of an organic acid and an organic base to achieve a desired cleaning effect on a substrate surface.

For example, one known chemistry contains an organic compound and an ammonium compound in deionized water at an acidic pH for cleaning a substrate surface and preventing brush loading. Other known acidic chemistries contain organic compounds and a fluoride compound in deionized water for cleaning a substrate surface as well as the subsurface while preventing brush loading. However, the use of fluoride compounds presents a number of concerns, such as environmental, safety and health issues, erosion of oxides, corrosion of copper, and the development of water marks to name a few.

Most of the cleaning chemistries known in the art rely on undercutting of the contaminants at the substrate surface for efficient cleaning. As the geometry of the devices on semiconductor substrates continues to decrease, the amount of acceptable material loss on the substrate due to the post CMP cleaning process is also decreased. Therefore, the use of highly corrosive chemistries that clean by copper or oxide dissolution or the use of fluorides that clean by oxide etching becomes less desirable, while the use of gentler cleaning chemistries using organic acids becomes more desirable.

However, a problem with cleaning chemistries employing organic acids or salts thereof is that such organic acids are subject to biological growth, which can result in a reduction in the effectiveness of the cleaning chemistry.

Accordingly, it is desirable to provide a post CMP cleaning solution including an organic acid that effectively treats a semiconductor component surface to remove metal and other residues while preventing biological growth in the cleaning solution.

### SUMMARY

Post CMP solutions are described herein which effectively clean semiconductor components to remove metals such as copper and/or other residues from a metal or low k surface such as an interconnect after a CMP process while effectively minimizing or preventing biological growth from occurring within the cleaning solutions.

An exemplary cleaning solution for cleaning a substrate surface comprises at least one cleaning agent including an organic acid compound that is a strong complexing agent of metals such as copper, and at least one organic amine to buffer the pH and complex copper and solubilize organic residues on substrate surfaces. The cleaning solution further includes a preservative compound that substantially minimizes or prevents biological activity (e.g., bacteria and/or other microbial growth). The preservative is preferably an organic acid compound that also enhances the removal of metals and metal oxides from a substrate surface. The cleaning solution preferably has a pH in a range from about 2 to about 7.

The cleaning solutions described herein can be contacted with a surface of a semiconductor component to effectively clean the component surface while inhibiting or preventing microbial growth within the cleaning solutions.

The above and still further features and advantages will become apparent upon consideration of the following detailed description of specific embodiments thereof.

### DETAILED DESCRIPTION

Cleaning chemistries or solutions that are effective for cleaning substrate surfaces that include metal debris and other contaminants include at least one cleaning agent, at least one organic amine compound, and at least one suitable preservative compound that substantially minimizes or prevents biological growth or activity in the cleaning solutions. The cleaning agent preferably includes an organic acid compound that effectively removes metals, oxides and other residues while not being highly corrosive to a substrate surface. In addition, the preservative compound is preferably an organic acid compound that serves a dual function in effectively removing residues from the substrate surface as well as substantially inhibiting, minimizing or preventing biological growth or biological activity in the cleaning solution.

The cleaning solutions are particularly effective in post chemical mechanical polishing or planarization (CMP) processes of semiconductor component surfaces, where the removal of metals such as copper, oxides, organic residues and/or other contaminating residues or impurities from the component surface is required. The combination of organic acids with one or more organic amines in the cleaning solutions facilitate the effective removal of such contaminating residues by dissolving metal oxides (e.g., copper oxides) and/or complexing metals to facilitate removal of such metals as well as removing organic and/or other residues, while being non-oxidizing to the substrate surface to as to minimize corrosion of copper or other metal interconnects.

Organic amine compounds that are suitable for use in the cleaning solutions are those that are capable of breaking down and/or removing organic residues from the surface. Exemplary organic amine compounds that are effective in combination with the organic acids of the cleaning solutions include, without limitation, primary, secondary or tertiary aliphatic amines such as methylamine, dimethylamine, trimethylamine, ethylamine, diethylamine, triethylamine, and alkanolamines (e.g., monoethanolamine, diethanolamine, aminoethanolamine, triethanolamine, isopropanolamine, diisopropanolamine, triisopropanolamine, (aminoethylamino)ethanol, etc.), aromatic amines, heterocyclic amines, and mixtures thereof.

Organic acid compounds that are suitable for use in the cleaning solutions include, without limitation, citric acid, oxalic acid, tartaric acid, succinic acid gluconic acid, malic acid, malonic acid, maleic acid, glutaric acid, fumaric acid and mixtures thereof. These organic acid compounds are effective as cleaning agents for removing, complexing and/or dissolving metals such as copper, oxides and other residues from the substrate surface while not being too strong to corrode copper and/or other metals exposed on the substrate surface. However, such acids are also susceptible to biological or microbial growth. Thus, unless a suitable additive is provided to protect the solution, cleaning solutions utilizing such organic acids can become less effective over time due to microbial activity and growth in the solutions.

Suitable preservative compounds are provided in the cleaning solutions to substantially minimize or prevent microbial growth therein. As noted above, these preservative compounds are preferably organic acid compounds that, in addition to providing a preservative effect for the solution, also assist in the removal of residues from the substrate surface. Exemplary organic acid compounds that are useful as preservatives in the cleaning solutions include, without limitation, salicylic acid, benzoic acid, sorbic acid, formic acid, acetic acid, lactic acid, propionic acid, and mixtures thereof.

Thus, the cleaning solutions preferably include one or more organic acids noted above as cleaning agents in combination with one or more organic acids noted above as preservatives. The one or more organic acids that serve as cleaning agents are preferably provided in the cleaning solution in a greater concentration in comparison to the one or more organic acids that serve as preservatives.

The cleaning solutions can further include any conventional and/or other types of suitable additives (e.g., surfactants, sticking agents such as polyethylene glycol or polypropylene glycol, etc.) that enhance the performance and effect of the cleaning solutions. For example, any one or more suitable types of surfactants, such as non-ionic, anionic, cationic, zwitterionic and/or amphoteric surfactants, can be provided in the cleaning solutions to enhance wetting of hydrophobic surfaces of the substrate during cleaning applications.

The cleaning solutions can be prepared by mixing the compounds together in any suitable manner in a solvent or solution such as deionized water so as to form a generally homogenous solution. Preferably, the cleaning solutions are prepared so as to have a pH within the range from about 2 to about 7, more preferably in a moderately acidic pH range (e.g., a pH from about 3 to about 5).

The cleaning solutions can include from about 2.5% to about 25% by weight of one or more organic acid cleaning compounds, from about 0.25% to about 2.5% by weight of one or more preservative compounds, and about 1.0% to about 10% by weight of one or more organic amine compounds in a suitable solvent such as deionized water.

The weight percentage ranges noted above refer to undiluted cleaning solutions, and such cleaning solutions are preferably diluted to suitable concentrations prior to being used in a cleaning application. For example, the cleaning solutions having chemistries within the weight percentage ranges as noted above can be diluted from about 20 times to about 100 times with deionized water while ensuring an effective cleaning of a substrate surface at such diluted levels.

Preferably, a diluted cleaning solution includes from about 0.05% to about 0.5% by weight of one or more organic acid cleaning compounds (e.g., citric acid and/or oxalic acid), from about 0.005% to about 0.05% by weight of one or more preservative compounds (e.g., salicylic acid), and about 0.015% to about 0.15% by weight of one or more organic amine compounds (e.g., isopropanolamine and/or triethanolamine) in deionized water.

In one exemplary embodiment, a cleaning solution includes from about 10-15% by weight of citric acid, from about 0-5% by weight of tartaric acid, from about 0-2% by weight of salicylic acid, and from about 0-5% by weight of isopropanolamine in deionized water. This solution can be diluted about 20-100 times to diluted concentrations in deionized water that fall within the ranges noted above. Preferably, the cleaning solution has a pH in the range from about 2 to about 7, most preferably a pH of about 4.

Upon obtaining the desired concentration for a cleaning solution (e.g., by appropriate dilution with deionized water from initial concentrations to desired cleaning concentrations), a cleaning solution is applied in any conventional or other suitable manner to the surface of a substrate. In an exemplary embodiment, a semiconductor wafer is provided with active regions formed in the wafer and with copper interconnects that are deposited in etched lines along the wafer and connect with the active regions. The wafer surface has been planarized using a CMP process. A cleaning solution having a suitable chemistry as described above is then applied to contact the wafer surface in a post-CMP cleaning process. The contacting of the cleaning solution with the wafer surface can be performed, for example, by brushing or scrubbing the wafer surface with the cleaning solution, by spraying the cleaning solution onto the wafer surface, by immersing or soaking portions of the wafer in a tank of the cleaning solution, and combinations thereof.

The component concentrations for the cleaning solutions noted above yield highly effective post CMP cleaning solutions that are effective in removing copper and copper oxide residues, as well as other residues, from a substrate surface. In addition, the moderate pH value of the organic acid or acids in the cleaning solutions prevents excessive copper oxidation and dissolution. The one or more preservative compounds further inhibit or prevent microbial growth or microbial activity in the cleaning solutions, which enhance the effectiveness and longevity of the cleaning solutions prior to and during use in Post CMP or other cleaning operations. For example, when salicylic acid is provided as a preservative with a cleaning agent such as citric acid in a cleaning solution and at the concentration ranges as noted above, the salicylic acid protects the citrate based solution by inhibiting or preventing microbial growth.

The use of one or more organic amine compounds in the cleaning solutions also enhances the removal of organic residues from the substrate surface. This is an enhancement over conventional acidic post CMP chemistries that are not as effective in removing organic residues from surfaces.

Having described novel cleaning solutions including preservative compounds for post CMP cleaning processes and corresponding methods for cleaning semiconductor component surfaces with such solutions, it is believed that other modifications, variations and changes will be suggested to those skilled in the art in view of the teachings set forth herein. It is therefore to be understood that all such variations, modifications and changes are believed to fall within the scope as defined by the appended claims.

1. A cleaning solution comprising:
at least one cleaning agent comprising an organic acid compound;
at least one preservative compound that substantially minimizes or prevents microbial growth in the cleaning solution; and
at least one amine compound.

2. The solution of claim 1, wherein the pH of the solution is in the range from about 2 to about 7.

3. The solution of claim 1, wherein the pH of the solution is no greater than about 5.

4. The solution of claim 1, wherein the at least one cleaning agent is selected from the group consisting of citric acid, oxalic acid, tartaric acid, succinic acid gluconic acid, malic acid, malonic acid, maleic acid, glutaric acid, fumaric acid and mixtures thereof.

5. The solution of claim 4, wherein the at least one preservative compound is selected from the group consisting of salicylic acid, benzoic acid, sorbic acid, formic acid, acetic acid, lactic acid, propionic acid, and mixtures thereof.

6. The solution of claim 1, wherein the solution includes from about 2.5% to about 25% by weight of the at least one cleaning agent in the solution, from about 0.25% to about 2.5% by weight of the at least one preservative compound in the solution, and from about 1.0% to about 10% by weight of the at least one organic amine compound in the solution.

7. The solution of claim 1, wherein the solution includes from about 0.05% to about 0.5% by weight of the at least one cleaning agent in the solution, from about 0.005% to about 0.05% by weight of the at least one preservative compound in the solution, and from about 0.015% to about 0.15% by weight of the at least one organic amine compound in the solution.

8. The solution of claim 1, wherein the at least one cleaning agent comprises citric acid, and the preservative compound comprises salicylic acid.

9. The solution of claim 8, wherein at least one amine compound comprises at least one of isopropanolamine and triethanolamine.

10. The solution of claim 9, wherein the at least one cleaning agent includes from about 10-15% by weight of citric acid and from about 0-5% by weight of tartaric acid in the solution, the at least one preservative compound includes from about 0-2% by weight of salicylic acid in the solution, and the at least one organic amine compound includes from about 0-5% by weight of isopropanolamine in the solution.

11. A method of cleaning a semiconductor component, the method comprising:
providing a cleaning solution comprising at least one cleaning agent including an organic acid compound, at least one preservative compound that substantially minimizes or prevents microbial growth in the cleaning solution, and at least one amine compound; and
contacting a surface of the semiconductor component with the cleaning solution.

12. The method of claim 11, wherein the pH of the solution is in the range from about 2 to about 7.

13. The method of claim 11, wherein the pH of the solution is no greater than about 5.

14. The method of claim 11, wherein the at least one cleaning agent is selected from the group consisting of citric acid, oxalic acid, tartaric acid, succinic acid gluconic acid, malic acid, malonic acid, maleic acid, glutaric acid, fumaric acid and mixtures thereof.

15. The method of claim 14, wherein the at least one preservative compound is selected from the group consisting of salicylic acid, benzoic acid, sorbic acid, formic acid, acetic acid, lactic acid, propionic acid, and mixtures thereof.

16. The method of claim 15, further comprising:
prior to contacting the surface of the semiconductor component with the cleaning solution, diluting the cleaning solution from about 20 times to about 100 time with deionized water such that the diluted cleaning solution includes from about 0.05% to about 0.5% by weight of the at least one cleaning agent in the solution, from about 0.005% to about 0.05% by weight of the at least one preservative compound in the solution, and from about 0.015% to about 0.15% by weight of the at least one organic amine compound in the solution.

17. The method of claim 11, wherein the at least one cleaning agent comprises citric acid, and the preservative compound comprises salicylic acid

18. The method of claim 17, wherein at least one amine compound comprises at least one of isopropanolamine and triethanolamine.

19. The method of claim 18, wherein the at least one cleaning agent includes from about 10-15% by weight of citric acid and about 0-5% by weight of tartaric acid in the solution, the at least one preservative compound includes from about 0-2% by weight of salicylic acid in the solution, and the at least one organic amine compound includes from about 0-5% by weight of isopropanolamine in the solution.
